(19) United States
(12) Patent Application Publication
(10) Pub. No.: US 2024/0198572 A1
(43) Pub. Date: Jun. 20, 2024

(54) INDUSTRIAL MACHINE

(71) Applicant: THE JAPAN STEEL WORKS, LTD., Tokyo (JP)

(72) Inventor: Ryo OKAWACHI, Tokyo (JP)

(21) Appl. No.: 18/519,041

(22) Filed: Nov. 26, 2023

(30) Foreign Application Priority Data
Dec. 14, 2022 (JP) 2022-199382

(51) Int. Cl. B29C 45/76; B29C 45/17; B29C 45/26; B29C 45/66

(52) U.S. Cl. CPC B29C 45/768; B29C 45/1774; B29C 45/2602; B29C 45/661; B29C 2045/1792; B29C 2945/76163

(57) ABSTRACT

A higher-level substrate and lower-level substrates communicatively connected to the higher-level substrate are provided. The higher-level substrate is configured to obtain identification information from each of the lower-level substrates at first timing, to obtain identification information from each of the lower-level substrates at second timing following the first timing, and when the identification information obtained at the first timing is different from the identification information obtained at the second timing, notify a user of substrate replacement of that lower-level substrate for each lower-level substrate.

### CROSS REFERENCE TO RELATED APPLICATIONS

This nonprovisional application is based on Japanese Patent Application No. 2022-199382 filed with the Japan Patent Office on Dec. 14, 2022, the entire contents of which are hereby incorporated by reference.

### BACKGROUND OF THE INVENTION

### Field of the Invention

The present disclosure relates to an industrial machine.

### Description of the Background Art

An injection molding machine that molds a molded article composed of resin such as plastic as a substrate has been known as an industrial machine to be used in a factory or the like. Patent Literature 1 (Japanese Patent Laying-Open No. 2018-111298) discloses an injection molding machine including substrates, a network being formed among the substrates. The injection molding machine in Patent Literature 1 detects abnormal communication by paying attention to packet loss in communication between substrates.

### SUMMARY OF THE INVENTION

In the industrial machine including substrates as described in Patent Literature 1, substrates can be removed from the industrial machine for each of substrates. Free replacement of substrates by a user of the industrial machine, however, may cause such inconvenience as safety of the industrial machine not being ensured or accelerated deterioration of the substrate due to defective attachment.

The present disclosure was made to solve such a problem, and an object thereof is to appropriately detect whether or not a substrate included in an industrial machine has been replaced.

An industrial machine according to the present disclosure includes a higher-level substrate and lower-level substrates communicatively connected to the higher-level substrate. The higher-level substrate is configured to obtain identification information from each of the lower-level substrates at first timing, to obtain identification information from each of the lower-level substrates at second timing following the first timing, and when the identification information obtained at the first timing is different from the identification information obtained at the second timing, to notify a user of substrate replacement of that lower-level substrate for each lower-level substrate.

The foregoing and other objects, features, aspects and advantages of this invention will become more apparent from the following detailed description of this invention when taken in conjunction with the accompanying drawings.

### BRIEF DESCRIPTION OF THE DRAWINGS

FIG. 1 is a diagram of an appearance of an injection molding machine representing an exemplary industrial machine.

FIG. 2 is a diagram for illustrating connection relation between a higher-level substrate and a lower-level substrate.

FIG. 3 is a first flowchart showing a procedure of obtaining identification information in a first embodiment.

FIG. 4 is a diagram for illustrating the identification information stored in a storage.

FIG. 5 is a diagram for illustrating information indicating relation of safety standards stored in the storage.

FIG. 6 is a second flowchart showing a procedure of obtaining identification information in the first embodiment.

FIG. 7 is a flowchart showing a procedure of obtaining identification information in a second embodiment.

FIG. 8 is a flowchart for storage of a result of inspection of the lower-level substrate at the time of shipping inspection.

FIG. 9 is a diagram for illustrating inspection data at the time of shipping inspection.

FIG. 10 is a flowchart for illustrating compensation processing after shipping.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### First Embodiment

### <Construction of Industrial Machine>

Description will be given below with reference to an injection molding machine as an exemplary industrial machine in a first embodiment. The industrial machine in the first embodiment is not limited to the injection molding machine. For example, another manufacturing machine, an inspection machine, or a transport machine may be applicable, and more specifically, a pressing machine or an analysis apparatus may be applicable. Injection molding machine 100 in the first embodiment molds a molded article composed of resin such as plastic as a substrate.

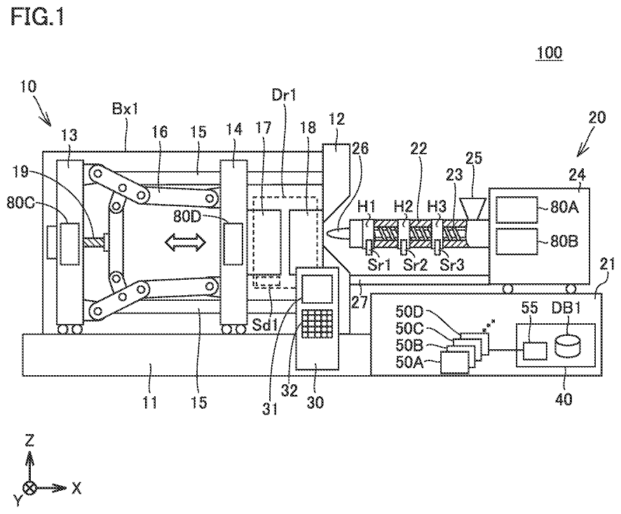

FIG. 1 is a diagram of an appearance of an injection molding machine 100 representing an exemplary industrial machine. Injection molding machine 100 is placed on an XY plane. A direction perpendicular to the XY plane is defined as a Z-axis direction. A positive direction along a Z axis in FIG. 1 may hereinafter be referred to as an upper surface side or above and a negative direction thereof may be referred to as a lower surface side or below. Though injection molding machine 100 shown in FIG. 1 is shown as a lateral injection molding machine, injection molding machine 100 in the present embodiment is not limited to the lateral type but may be a vertical injection molding machine.

Injection molding processing performed by injection molding machine 100 includes a mold closing step, an injection step, a pressure holding step, a mold opening step, a cooling step, an ejection step, and a plasticization step. Injection molding machine 100 repeatedly performs a cycle of the injection molding processing. Injection molding machine 100 can mold a molded article of various shapes and materials. Contents in the injection molding processing are different depending on a shape and a type of the material of the molded article.

Injection molding machine 100 includes a mold clamping apparatus 10 that clamps a mold, an injection apparatus 20 that melts and injects an injection material, and a control panel 30. Mold clamping apparatus 10 is arranged on a side of the positive direction along a Z axis of a bed 11. Injection apparatus 20 is arranged on the side of the positive direction along the Z axis of a base 21. Mold clamping apparatus 10 is arranged on a side of the negative direction along an X axis with respect to injection apparatus 20.

### <Mold Clamping Apparatus>

Mold clamping apparatus 10 in the present embodiment includes a fixed plate 12, a mold clamping housing 13, a moving plate 14, a tie bar 15, a mold clamping mechanism 16, molds 17 and 18, a ball screw 19, servo motors 80C and 80D, bed 11, and a housing Bx1. Bed 11 holds fixed plate 12, mold clamping housing 13, moving plate 14, and the like. Each of mold clamping housing 13 and moving plate 14 is constructed as being slidable over bed 11 in an X-axis direction.

Tie bar 15 is arranged between fixed plate 12 and mold clamping housing 13, and couples fixed plate 12 and mold clamping housing 13 to each other. Injection molding machine 100 in FIG. 1 includes four tie bars 15. Injection molding machine 100 may include, for example, five or more tie bars 15, without being limited to four tie bars.

Moving plate 14 is constructed as being slidable in the X-axis direction between fixed plate 12 and mold clamping housing 13. Mold clamping mechanism 16 is provided between mold clamping housing 13 and moving plate 14. Mold clamping housing 13 in the present embodiment includes a toggle mechanism. Mold clamping mechanism 16 may include a direct pressure type mold clamping mechanism. The direct pressure type mold clamping mechanism means a mold clamping cylinder.

Servo motor 80C is provided in mold clamping housing 13. Servo motor 80C drives mold clamping mechanism 16 with ball screw 19 being interposed. Ball screw 19 converts rotary motion from servo motor 80C into linear motion to drive mold clamping mechanism 16. Molds 17 and 18 are provided between fixed plate 12 and moving plate 14. Molds 17 and 18 are opened and closed as mold clamping mechanism 16 is driven. In other words, mold 17 is a mold movable by ball screw 19 and mold 18 is a mold fixed by fixed plate 12.

A step of transition from a state in which molds 17 and 18 are distant from each other to a state in which the molds are in intimate contact with each other is referred to as the “mold closing step.” A step of transition from the state in which molds 17 and 18 are in intimate contact with each other to the state in which the molds are distant from each other is referred to as the “mold opening step.” Servo motor 80C is used for the mold closing step and the mold opening step.

Injection molding machine 100 performs a step referred to as the “ejection step” after the mold opening step. The ejection step is a step of removing from mold 17, an injection material such as solidified resin after molds 17 and 18 are filled therewith. Specifically, a not-shown pin protrudes as a result of rotation of servo motor 80D so that the molded article in intimate contact with mold 17 is removed. Servo motor 80D provided in moving plate 14 is used for the ejection step.

Housing Bx1 contains mold clamping housing 13, moving plate 14, and molds 17 and 18. Housing Bx1 prevents a user from touching such a component as moving plate 14 driven by mold clamping mechanism 16 or molds 17 and 18. Housing Bx1 is provided with a safety door Dr1. The user on the outside of housing Bx1 can directly touch molds 17 and 18 in the inside of housing Bx1 by opening safety door Dr1.

Specifically, the user can do replacement of a mold or maintenance while safety door Dr1 is open. Injection molding machine 100 is constructed not to allow injection molding processing while safety door Dr1 is open. Injection molding machine 100 can thus suppress touching by the user onto molds 17 and 18 that are opened and closed. An opening sensor Sd1 is connected to safety door Dr1. Opening sensor Sd1 is a sensor that detects whether safety door Dr1 is open or closed. Opening sensor Sd1 outputs a result of detection of the open and closed state of safety door Dr1 to a controller 40.

### <Injection Apparatus>

Injection apparatus 20 includes a cylinder 22, a screw 23, a drive mechanism 24, a hopper 25, an injection nozzle 26, a nozzle touch apparatus 27, servo motors 80A and 80B, heaters H1, H2, and H3, and temperature sensors Sr1, Sr2, and Sr3.

Cylinder 22 contains screw 23 that kneads the injection material. Cylinder 22 has a columnar shape with end portions on a nozzle side and a hopper side, respectively. Injection molding machine 100 performs a step referred to as the “plasticization step” with the use of screw 23. The plasticization step is a step of kneading injected resin by heating of cylinder 22 and rotation of screw 23.

Servo motor 80B in drive apparatus 24 rotates screw 23 with the X-axis direction being defined as a central axis. In other words, servo motor 80B is a motor used for the plasticization step. Injection molding machine 100 performs a step referred to as the “injection step” and a step referred to as the “pressure holding step.” The injection step is a step of injecting resin plasticized in the plasticization step into molds 17 and 18.

The pressure holding step is a step of applying a pressure to hold the resin injected in the injection step in molds 17 and 18. Being driven by servo motor 80A, screw 23 slides in the negative direction along the X-axis direction. The plasticized resin is thus injected into molds 17 and 18. Servo motor 80A is used for the injection step or the pressure holding step.

Hopper 25 is provided on a side of the positive direction along the Z axis of cylinder 22, and a granular injection material yet to be plasticized is stored therein. The injection material stored in hopper 25 is transported to the inside of cylinder 22 as screw 23 is driven.

Heaters H1, H2, and H3 are each a band heater that covers a part of cylinder 22. An injection material is heated by heaters H1, H2, and H3 and kneaded. Temperature sensors Sr1, Sr2, and Sr3 measure temperatures of regions heated by heaters H1, H2, and H3, respectively. Temperature sensors Sr1, Sr2, and Sr3 are each implemented, for example, by a thermocouple. Controller 40 obtains temperatures detected by temperature sensors Sr1, Sr2, and Sr3 and controls heaters H1, H2, and H3 based on the obtained detection temperatures.

The kneaded injection material is transported to injection nozzle 26. Nozzle touch apparatus 27 slides injection apparatus 20 in the X-axis direction to bring injection nozzle 26 into contact with a sprue bush of mold 18. The injection material is thus injected into mold 18.

Base 21 contains controller 40 and lower-level substrates including lower-level substrates 50A, 50B, 50C, and 50D. Controller 40 contains a higher-level substrate 55 and a storage DB1. Higher-level substrate 55 is communicatively connected to the lower-level substrates. Each of the lower-level substrates is connected, for example, to an apparatus for a specific application in injection molding processing such as temperature sensor Sr1, servo motor 80D, and a control panel 30.

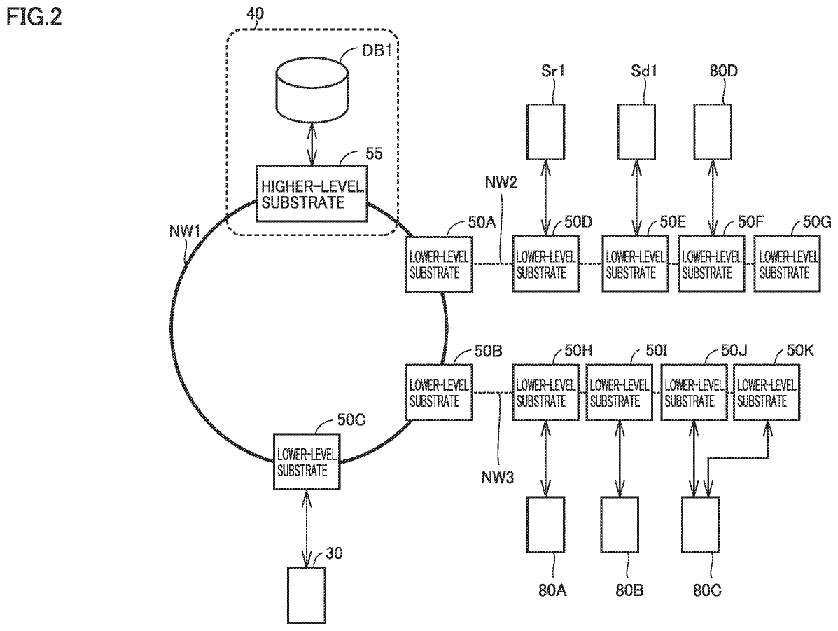

Higher-level substrate 55 controls various apparatuses included in injection molding machine 100 through the lower-level substrates. Applications of the lower-level substrates and more detailed connection relation between higher-level substrate 55 and the lower-level substrates will be described with reference to FIG. 2.

### <Control Panel>

Control panel 30 shows information on the injection molding processing and accepts an operation by a user. Control panel 30 is electrically connected to controller 40 with the lower-level substrates being interposed. In an example in FIG. 1, control panel 30 is provided on the side of the negative direction along a Y axis of injection molding machine 100. In one aspect, control panel 30 may be provided separately from injection molding machine 100, and may be arranged, for example, in a room different from the room where injection molding machine 100 is arranged.

Control panel 30 includes a display apparatus 31 and an input apparatus 32. Display apparatus 31 is typically implemented by a liquid crystal display or an organic electro-luminescence (EL) display. Input apparatus 32 may include, for example, buttons. In one aspect, display apparatus 31 and input apparatus 32 may integrally be provided as a touch panel. Control panel 30 may include a microphone and a speaker and may accept an operation by the user through voice and sound.

### <Connection Relation Among Various Substrates Included in Injection Molding Machine>

FIG. 2 is a diagram for illustrating connection relation between higher-level substrate 55 and lower-level substrates. Higher-level substrate 55 in controller 40 is connected to lower-level substrates 50A, 50B, and 50C through a ring-type network NW1. Lower-level substrate 50A is further connected to a lower-level substrate 50D, a lower-level substrate 50E, a lower-level substrate 50F, and a lower-level substrate 50G through a bus-type network NW2. Lower-level substrate 50B is connected to a lower-level substrate 50H, a lower-level substrate 50I, a lower-level substrate 50J, and a lower-level substrate 50K through a bus-type network NW3. In one aspect, a form of connection of network NW1 may be the bus type and the form of connection of networks NW2 and NW3 may be the ring type. The form of connection of networks NW1 to NW3 may be a form of connection other than the ring type and the bus type, and for example, a star type or a mesh type may be applicable. In other words, so long as there are a substrate that functions as the higher-level substrate and a substrate that functions as the lower-level substrate in networks NW1 to NW3, any form of connection of networks NW1 to NW3 may be applicable.

Each of lower-level substrates 50A to 50K may be stored in an independent housing. In one aspect, some of lower-level substrates 50A to 50K may be stored in the same housing. For example, since lower-level substrates 50E, 50F, and 50G are all associated with servo motor 80D, they may be stored in the same housing.

As shown in FIG. 2, base 21 of injection molding machine 100 includes a single higher-level substrate 55 and eleven lower-level substrates 50A to 50K. Each of higher-level substrate 55 and lower-level substrates 50A to 50K includes a CPU. The CPU executes a program stored in a read only memory (ROM) by developing the program on a random access memory (RAM). Alternatively, each of higher-level substrate 55 and lower-level substrates 50A to 50K may include dedicated hardware circuitry. In other words, each of higher-level substrate 55 and lower-level substrates 50A to 50K may be implemented by an application specific integrated circuit (ASIC) or a field-programmable gate array (FPGA). Alternatively, higher-level substrate 55 and lower-level substrates 50A to 50K may be implemented by circuitry which is combination of a processor and a memory, an ASIC, an FPGA, and the like as appropriate.

Storage DB1 may be implemented, for example, by a hard disk drive (HDD) or a flash solid state drive (SSD). Storage DB1 does not have to be arranged in injection molding machine 100. In one aspect, storage DB1 may be a cloud server managed by a manufacturer of injection molding machine 100.

Lower-level substrate 50C is connected to control panel 30. Higher-level substrate 55 outputs data to be shown on display apparatus 31 to control panel 30 through lower-level substrate 50C. Control panel 30 outputs data inputted to input apparatus 32 to higher-level substrate 55 through lower-level substrate 50C.

Lower-level substrate 50D is connected to temperature sensor Sr1. Lower-level substrate 50D converts a detection value in an analog format received from temperature sensor Sr1 into a detection value in a digital format. In other words, the application of lower-level substrate 50D is A/D conversion of the detection value from the temperature sensor. Lower-level substrate 50D transmits the resultant detection value in the digital format to lower-level substrate 50A.

Lower-level substrate 50E is connected to opening sensor Sd1. Lower-level substrate 50E receives a detection value indicating the open and closed state of safety door Dr1 (see FIG. 1) from opening sensor Sd1. Lower-level substrate 50E outputs the detection value indicating the open and closed state of safety door Dr1 to lower-level substrate 50F. The application of lower-level substrate 50E is detection of the open and closed state of safety door Dr1. Lower-level substrate 50E may correspond to the “second lower-level substrate” in the present disclosure.

Lower-level substrate 50F is a substrate that controls servo motor 80D. The application of lower-level substrate 50F is control of the servo motor. Lower-level substrate 50F controls operations of the servo motor by controlling a servo amplifier. Lower-level substrate 50F may correspond to the “first lower-level substrate” in the present disclosure.

Lower-level substrate 50F generates an instruction for control of servo motor 80D in accordance with an instruction from higher-level substrate 55. When lower-level substrate 50F receives a detection value indicating that safety door Dr1 is open from lower-level substrate 50E, it deactivates servo motor 80D. Thus, injection molding machine 100 can achieve suppression of touching by the user onto molds 17 and 18 through open safety door Dr1.

Lower-level substrate 50G is a substrate that makes determination as to abnormality of output from lower-level substrate 50F. Lower-level substrate 50G generates an instruction for control of servo motor 80D in accordance with an instruction from higher-level substrate 55, similarly to lower-level substrate 50F. Lower-level substrate 50G transmits the generated instruction to lower-level substrate 50F. The application of lower-level substrate 50G is determination as to abnormality of output from another substrate. Lower-level substrate 50G may correspond to the “third lower-level substrate” in the present disclosure.

Lower-level substrate 50F determines whether or not the instruction generated by lower-level substrate 50F itself for control of servo motor 80D is consistent with the instruction generated by lower-level substrate 50G. When the instructions are consistent with each other, lower-level substrate 50F controls servo motor 80D in accordance with the instruction it generated, regarding that no problem has arisen. When the instruction generated for control of servo motor 80D by lower-level substrate 50F itself is inconsistent with the instruction generated by lower-level substrate 50G, on the other hand, lower-level substrate 50F deactivates servo motor 80D, regarding that a problem has arisen.

In injection molding machine 100 in the first embodiment, lower-level substrate 50F determines whether or not to drive servo motor 80D based on information received from lower-level substrates 50E and 50G. A condition set for servo motor 80D in order to ensure normal operations of servo motor 80D for safety protection of the user is referred to as safety standards. The safety standards are defined for each type of the industrial machine, for example, by an organization laid down by the government.

Sales of a product that fails to meet the safety standards may not be permitted. Among lower-level substrates 50A to 50K, there are a substrate relating to the safety standards and a substrate not relating to the safety standards. Whether or not lower-level substrates 50A to 50K relate to the safety standards is determined depending on the application of the substrate. Lower-level substrates 50E, 50F, and 50G are substrates relating to the safety standards. A manufacturer of injection molding machine 100 checks whether or not the safety standards defined for lower-level substrates 50E, 50F, and 50G are met at the time of shipping of injection molding machine 100, and thereafter it ships injection molding machine 100.

Lower-level substrate 50A is a substrate that relays information between higher-level substrate 55 and lower-level substrate 50D. The application of lower-level substrate 50A is relay of information between the substrates. Network NW1 and network NW2 are different from each other in communication standards. Lower-level substrate 50A converts information in conformity with the communication standards of network NW1 and network NW2, and transmits and receives information to and from higher-level substrate 55 and lower-level substrate 50D. The application of lower-level substrates 50B and 50C is relay of information between the substrates, similarly to lower-level substrate 50A.

Lower-level substrates 50H, 50I, and 50J are substrates that control respective servo motors 80A, 80B, and 80C. In other words, the application of lower-level substrates 50H, 50I, and 50J is control of the servo motor similarly to lower-level substrate 50F.

Lower-level substrate 50K is a substrate that detects a value of a voltage supplied to servo motor 80C. In other words, the application of lower-level substrate 50K is detection of the voltage value. Though FIG. 2 shows an example in which lower-level substrate 50K detects the voltage value only of servo motor 80C, it may further detect the values of the voltages supplied to servo motors 80A, 80B, and 80D. Though FIG. 2 illustrates an example in which injection molding machine 100 includes eleven lower-level substrates 50A to 50K, in one aspect, injection molding machine 100 may include more than eleven lower-level substrates.

Higher-level substrate 55 outputs an instruction to lower-level substrates 50A to 50K based on an input from the user to control such an apparatus as servo motors 80A to 80D, to thereby perform injection molding processing. During the injection molding processing, higher-level substrate 55 may cause storage in storage DB1, of information on the injection molding processing obtained from lower-level substrates 50A to 50K. In injection molding machine 100 in the first embodiment, identification information of lower-level substrates 50A to 50K in addition to the information on the injection molding processing is obtained and stored in storage DB1.

The identification information for identification of lower-level substrates 50A to 50K will be described below. Each of lower-level substrates 50A to 50K includes a memory. In the memory of the lower-level substrate, information indicating the application of the substrate and a serial number are stored. The serial number is a specific number provided by the manufacturer of the lower-level substrate for each lower-level substrate for identification of each lower-level substrate.

In the first embodiment, the serial number is provided serially for each application of the substrate. There is no substrate having the same serial number among lower-level substrates the same in application. On the other hand, there may be substrates having the same serial number among lower-level substrates different in application. For example, injection molding machine 100 may include a substrate provided with “01” as the serial number, the application of which is detection of the voltage value, and a substrate provided with “01” as the serial number, the application of which is relay of information between the substrates.

In injection molding machine 100, when the information indicating the application of the substrate and the serial number can be obtained, one substrate among lower-level substrates 50A to 50K is uniquely identified. In the first embodiment, the identification information for identification of lower-level substrates 50A to 50K is composed of the information indicating the application of the substrate and the serial number.

Higher-level substrate 55 can obtain the information indicating the application of the substrate and the serial number from each of lower-level substrates 50A to 50K by accessing lower-level substrates 50A to 50K through networks NW1 to NW3. Injection molding machine 100 in the first embodiment manages lower-level substrates 50A to 50K by obtaining the identification information of each of lower-level substrates 50A to 50K. In the memory of each of lower-level substrates 50A to 50K in the first embodiment, in addition to the information indicating the application of the substrate and the serial number, information indicating a version of software, information indicating a version of hardware, and information indicating time of manufacturing of the lower-level substrate are stored.

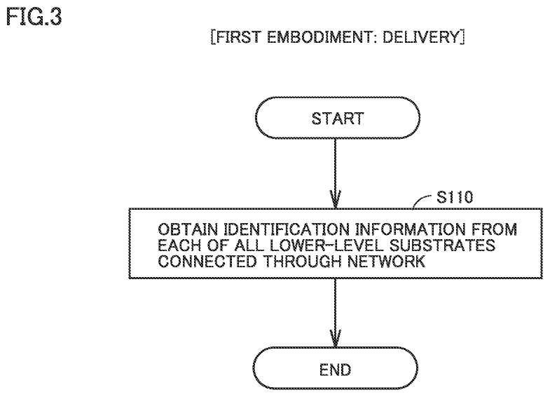

FIG. 3 is a first flowchart showing a procedure of obtaining the identification information in the first embodiment. In injection molding machine 100, the flowchart shown in FIG. 3 is performed at the time of shipping of injection molding machine 100. More specifically, a worker of a manufacturer that manufactures injection molding machine 100 inspects whether or not injection molding machine 100 operates normally at the time of shipping of injection molding machine 100. This inspection at the time of shipping will simply be referred to as “shipping inspection” below. The worker of the manufacturer has higher-level substrate 55 execute a program for performing the flowchart shown in FIG. 3 at the time of shipping inspection.

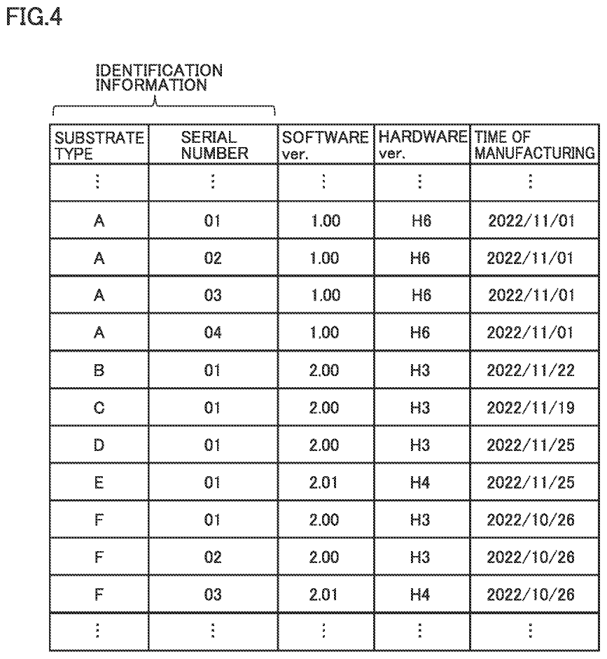

Higher-level substrate 55 in controller 40 obtains the identification information from each of lower-level substrates 50A to 50K connected through networks NW1 to NW3 (step S110). In other words, in step S110, higher-level substrate 55 obtains the information that allows identification of lower-level substrates 50A to 50K stored in injection molding machine 100 from each of lower-level substrates 50A to 50K and has the information stored in storage DB1. FIG. 4 is a diagram for illustrating the identification information stored in storage DB1. A substrate type is information indicating the application of the lower-level substrate described above.

The type of the substrate and the serial number of lower-level substrates 50A to 50K will specifically be described with reference to FIGS. 2 and 4. A substrate type “A” indicates that the application of the lower-level substrate is control of the servo motor. The substrate identified by a serial number “01” of the substrate type “A” is lower-level substrate 50F. The substrate identified by a serial number “02” of the substrate type “A” is lower-level substrate 50H. The substrate identified by a serial number “03” of the substrate type “A” is lower-level substrate 50I. The substrate identified by a serial number “04” of the substrate type “A” is lower-level substrate 50J.

A substrate type “B” indicates that the application of the lower-level substrate is detection of abnormality of output from another substrate. The substrate identified by the serial number “01” of the substrate type “B” is lower-level substrate 50G. A substrate type “C” indicates that the application of the lower-level substrate is detection of the open and closed state of safety door Dr1. The substrate identified by the serial number “01” of the substrate type “C” is lower-level substrate 50E. A substrate type “D” indicates that the application of the lower-level substrate is A/D conversion of the detection value from the temperature sensor. The substrate identified by the serial number “01” of the substrate type “D” is lower-level substrate 50D.

A substrate type “E” indicates that the application of the lower-level substrate is detection of the voltage value. The substrate identified by the serial number “01” of the substrate type “E” is lower-level substrate 50K. A substrate type “F” indicates that the application of the lower-level substrate is relay of information between the substrates. The substrate identified by the serial number “01” of the substrate type “F” is lower-level substrate 50A. The substrate identified by the serial number “02” of the substrate type “F” is lower-level substrate 50B. The substrate identified by the serial number “03” of the substrate type “F” is lower-level substrate 50C.

Higher-level substrate 55 can thus uniquely identify one lower-level substrate among lower-level substrates 50A to 50K based on the identification information including the substrate type and the serial number. As shown in FIG. 4, information indicating the version of the software and the hardware of each of lower-level substrates 50A to 50K and information indicating time of manufacturing thereof are stored in storage DB1. In the first embodiment, the time of manufacturing of each substrate is stored in storage DB1. Thus, in injection molding machine 100 shown in FIG. 1, whether or not a substrate at specific time of manufacturing is used in injection molding machine 100 can readily be known. For example, when the manufacturer that manufactures the substrate requests collection of a substrate manufactured at specific time, the manufacturer of injection molding machine 100 and the user can readily know whether or not the substrate manufactured at the specific time is used in injection molding machine 100. Thus, information on lower-level substrates 50A to 50K is written in storage DB1 by higher-level substrate 55 at the time of shipping inspection of injection molding machine 100.

When higher-level substrate 55 obtains identification information of a lower-level substrate and it is the identification information it recognizes for the first time, higher-level substrate 55 may have time and day of first recognition stored in storage DB1 as the day of start of use. Higher-level substrate 55 can thus manage time and day of start of use of each lower-level substrate by injection molding machine 100.

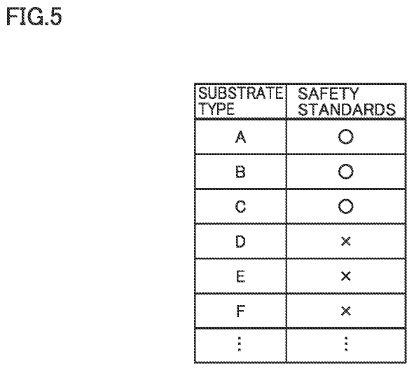

FIG. 5 is a diagram for illustrating information indicating relation of safety standards stored in storage DB1. As shown in FIG. 5, information indicating relation with the safety standards is stored in storage DB1 for each substrate type. The substrate types “A”, “B”, and “C” relate to the safety standards and the substrate types “D”, “E”, and “F” do not relate to the safety standards. The information shown in FIG. 5 is inputted in advance by the manufacturer of injection molding machine 100 shown in FIG. 1 at the time of shipping inspection of injection molding machine 100.

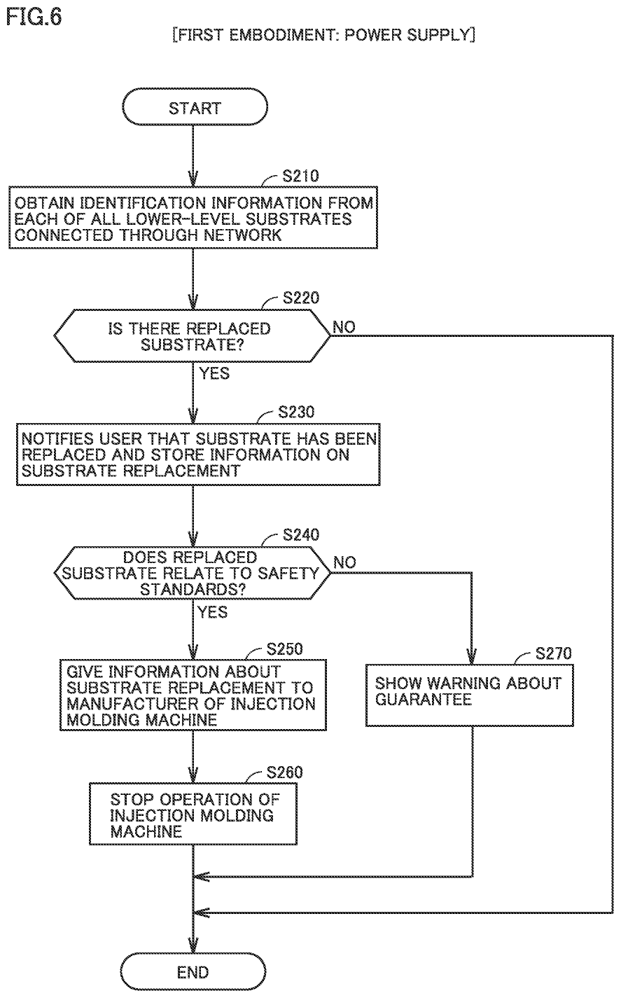

FIG. 6 is a second flowchart showing a procedure of obtaining the identification information in the first embodiment. In the description of a second flow showing the procedure of obtaining the identification information, FIG. 2 is also referred to as appropriate. The flowchart in FIG. 6 is performed by higher-level substrate 55 each time injection molding machine 100 shown in FIG. 1 is started up by being supplied with electric power after it is shipped to the user.

Higher-level substrate 55 obtains the identification information from each of lower-level substrates 50A to 50K connected through networks NW1, NW2, and NW3 (step S210). In other words, as in the processing in step S110 in FIG. 3, higher-level substrate 55 obtains the information that allows identification of lower-level substrates 50A to 50K stored in injection molding machine 100 from each of lower-level substrates 50A to 50K and has the information stored in storage DB1. Specifically, higher-level substrate 55 obtains the information indicating the application of the substrate and the serial number by accessing the memory of each lower-level substrate.

Higher-level substrate 55 checks whether or not there is a removed lower-level substrate as compared with the state at the time of the shipping inspection (step S220). Specifically, higher-level substrate 55 compares the identification information obtained in step S110 in FIG. 3 with the identification information obtained in step S210 in FIG. 6. When the identification information obtained in step S110 is the same as the identification information obtained in step S210, higher-level substrate 55 determines that there is no removed substrate (NO in step S220) and quits the process.

When the identification information obtained in step S110 is not the same as the identification information obtained in step S210, higher-level substrate 55 determines that there is a removed lower-level substrate (YES in step S220), notifies the user that the substrate has been replaced, and has the information on substrate replacement stored (step S230). Specifically, higher-level substrate 55 has display apparatus 31 show that the substrate has been replaced. The user of injection molding machine 100 can thus recognize replacement of the lower-level substrate during a period from stop of supply of electric power until resumption of supply of electric power. Higher-level substrate 55 writes the identification information of the substrate before replacement and the removed substrate in storage DB1. Thus, in injection molding machine 100, a history of substrate replacement can be recorded in storage DB1.

Higher-level substrate 55 determines whether or not the application of the removed substrate relates to the safety standards (step S240). Higher-level substrate 55 determines whether or not the substrate type of the removed substrate relates to the safety standards based on the information shown in FIG. 5. When the removed substrate relates to the safety standards (YES in step S240), higher-level substrate 55 notifies the manufacturer of injection molding machine 100 that the substrate has been replaced (step S250). For example, higher-level substrate 55 access a server or the like managed by the manufacturer over the Internet and writes the information on substrate replacement in the server. Thereafter, higher-level substrate 55 stops the operation of injection molding machine 100 (step S260). Thus, injection molding machine 100 can suppress the operation thereof while the safety standards are not met. The stopped operation of injection molding machine 100 can be resumed by the worker of the manufacturer of injection molding machine 100. Thus, in injection molding machine 100 in the first embodiment, when the worker of the manufacturer of injection molding machine 100 replaces the substrate for the purpose of repair, the worker himself/herself that has carried out the repair can cancel a deactivated state of injection molding machine 100 to thereby promptly recover the state of injection molding machine 100.

When the removed substrate does not relate to the safety standards (NO in step S240), higher-level substrate 55 has display apparatus 31 show a warning about guarantee (step S270). The manufacturer of injection molding machine 100 guarantees the normal operation of injection molding machine 100 in a state at the time of the shipping inspection. When one of lower-level substrates 50A to 50K is replaced, the manufacturer of injection molding machine 100 is unable to guarantee the normal operation of injection molding machine 100 because a substrate different from the substrate at the time of the shipping inspection is used. Therefore, in step S270, higher-level substrate 55 notifies the user that the guarantee by the manufacturer of injection molding machine 100 becomes void. The user who has received the warning in step S270 can inquire of the manufacturer of injection molding machine 100 about a method of validating the guarantee again. In step S270, instead of the warning about the guarantee, higher-level substrate 55 may issue a warning indicating that injection molding machine 100 may not be able to normally operate because a different substrate is used.

Thus, in injection molding machine 100 in the first embodiment, when one of lower-level substrates 50A to 50K is replaced, the injection molding machine notifies the user that the substrate has been replaced and stops the operation of injection molding machine 100 or gives a warning about the guarantee. Thus, injection molding machine 100 in the first embodiment can appropriately detect whether or not the substrate included in the industrial machine has been replaced. In other words, injection molding machine 100 in the first embodiment can achieve suppression of occurrence of such an inconvenience as the operation of injection molding machine 100 with the safety standards not being met and use of injection molding machine 100 with the guarantee being void.

### Second Embodiment

In the first embodiment, the example in which substrate replacement is detected with a substrate configuration at the time of the shipping inspection being defined as the reference is described. In a second embodiment, a configuration for detection of replacement of a substrate based on storage of a substrate configuration in storage DB1 each time of start-up and comparison thereof with a latest substrate configuration stored in storage DB1 will be described. Description of a feature in the second embodiment similar to that in the first embodiment will not be repeated.

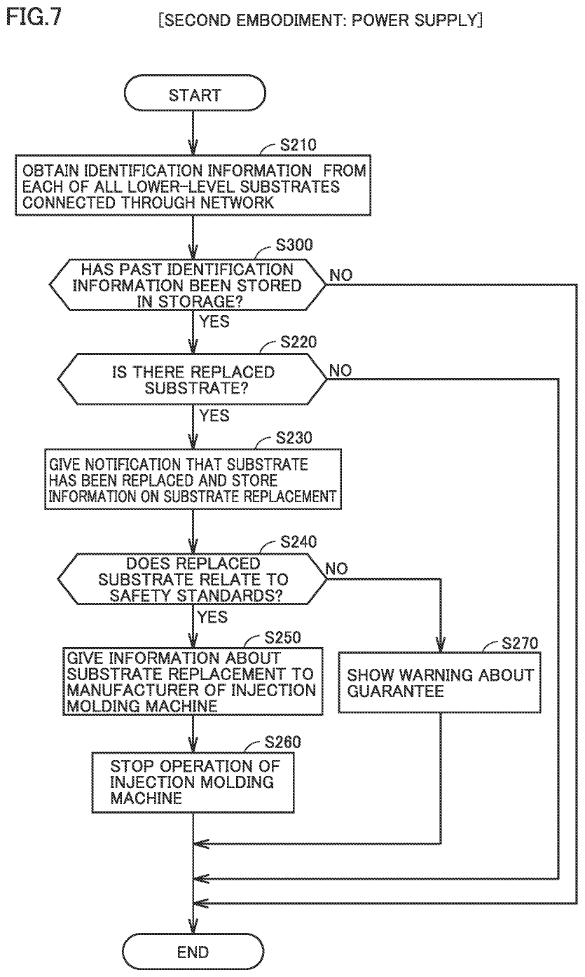

FIG. 7 is a flowchart showing a procedure of obtaining the identification information in the second embodiment. The flowchart in FIG. 7 is performed by higher-level substrate 55 each time electric power is supplied to injection molding machine 100 and injection molding machine 100 is started up. In the flowchart in FIG. 7, step S300 is added between step S210 and step S220 in the flowchart in FIG. 6.

Processing at the time of first start-up after shipping of injection molding machine 100 in the second embodiment to the user will be described below. At the time of first start-up after shipping of injection molding machine 100 to the user, higher-level substrate 55 obtains the identification information from each of lower-level substrates 50A to 50K connected through networks NW1, NW2, and NW3 (step S210). In FIG. 7 as well, higher-level substrate 55 obtains the information that allows identification of lower-level substrates 50A to 50K stored in injection molding machine 100 from each of lower-level substrates 50A to 50K and has the information stored in storage DB1. The higher-level substrate determines whether or not the identification information obtained in the past is stored in storage DB1 (step S300).

At the time of first start-up, the identification information of the lower-level substrate obtained before the first start-up may not be stored in storage DB1. Alternatively, past data in storage DB1 may have been lost due to occurrence of a failure or a human error. When there is no identification information to be compared with for determination as to whether or not the lower-level substrate has been replaced, higher-level substrate 55 quits the process (NO in step S300).

Processing at the time of start-up for the second time or later after shipping of injection molding machine 100 in the second embodiment to the user will now be described. At the time of start-up for the second time or later, higher-level substrate 55 obtains the identification information from each of lower-level substrates 50A to 50K connected through networks NW1, NW2, and NW3 (step S210). The higher-level substrate determines whether or not the identification information obtained in the past is stored in storage DB1 (step S300).

At the time of start-up for the second time or later, the identification information to be compared with for determination as to whether or not the lower-level substrate has been replaced is stored in storage DB1. Higher-level substrate 55 determines that past identification information is stored in storage DB1 (YES in step S300). Higher-level substrate 55 determines whether or not the substrate has been replaced based on comparison between the identification information of the lower-level substrate obtained in step S210 at the time of previous start-up and the identification information of the lower-level substrate obtained in step S210 at the time of present start-up (step S220). Since processing after step S220 is similar to steps S230 to 270 in FIG. 6, description will not be repeated.

Thus, in the second embodiment, the identification information of the lower-level substrate at the timing of start-up of injection molding machine 100 is compared with the identification information of the lower-level substrate at the time of start-up before that timing. In order to replace the lower-level substrate in injection molding machine 100, the user of injection molding machine 100 should temporarily stop supply of power to injection molding machine 100.

Injection molding machine 100 in the second embodiment can promptly detect that the substrate has been replaced by determining whether or not the substrate has been replaced at the timing of start of supply of power. Injection molding machine 100 in the second embodiment can also appropriately detect whether or not the substrate included in the industrial machine has been replaced as in the first embodiment. In other words, injection molding machine 100 in the second embodiment can achieve suppression of occurrence of such an inconvenience as the operation of injection molding machine 100 with the safety standards not being met and use of injection molding machine 100 with the guarantee being void.

Thus, in injection molding machine 100 in the second embodiment, the substrate configuration at the time of shipping inspection and the substrate configuration for each time of start-up are successively stored in storage DB1. The user of injection molding machine 100 in the second embodiment can thus readily keep track of a history of replacement of each substrate. In other words, traceability of the substrate used in injection molding machine 100 is improved. Injection molding machine 100 in the second embodiment can support works for maintenance of each substrate, such as prediction of the lifetime of each substrate or management of timing of placement of an order for a part, by informing the user of the history of replacement of each substrate.

Storage of the substrate configuration in storage DB1 each time of start-up, however, may increase a data capacity used in storage DB1. Therefore, an upper limit of the number of substrate configurations stored in storage DB1 may be set. For example, when the upper limit of the number of stored substrate configurations is set to two, only the latest substrate configuration and the substrate configuration stored immediately before the latest substrate configuration are stored in storage DB1.

Specifically, controller 40 erases data representing the oldest substrate configuration each time of start-up of injection molding machine 100, and it has data representing a newly obtained latest substrate configuration stored in storage DB1. In other words, controller 40 updates the substrate configuration stored in storage DB1. In this case, controller 40 detects whether or not the substrate has been replaced based on comparison between the latest substrate configuration and the substrate configuration stored immediately before the latest substrate configuration. Injection molding machine 100 can thus achieve suppression of increase in data capacity used in storage DB1.

### Third Embodiment

The example in which whether or not the substrate has been replaced is detected at the timing of supply of power to injection molding machine 100 is described in the first and second embodiments. In a third embodiment, a configuration for compensation for an operating state of the lower-level substrate at the time of maintenance of injection molding machine 100 will be described. Description of a feature in the third embodiment similar to that in the first embodiment will not be repeated.

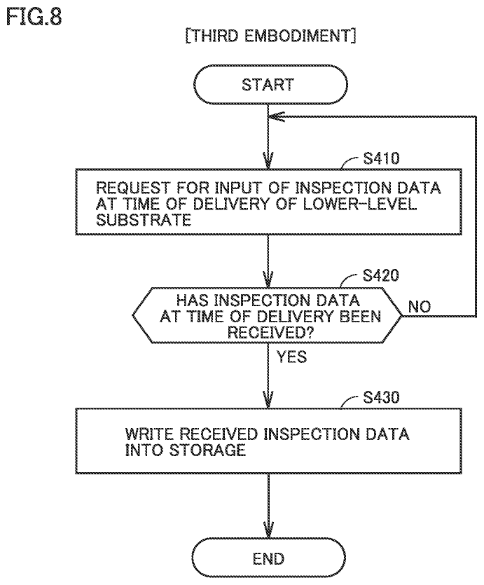

FIG. 8 is a flowchart for storage of a result of inspection of the lower-level substrate at the time of shipping inspection. The worker of the manufacturer that manufactures injection molding machine 100 has higher-level substrate 55 in controller 40 execute a program for performing the flowchart shown in FIG. 8 at the time of shipping inspection of injection molding machine 100.

Higher-level substrate 55 in controller 40 requests the worker of the manufacturer to input inspection data at the time of shipping inspection of the lower-level substrate (step S410). The inspection data refers to data indicating a result of inspection as to whether or not the lower-level substrate normally operates. Higher-level substrate 55 has display apparatus 31 show text that encourages input of the inspection data of the lower-level substrate. The worker of the manufacturer of injection molding machine 100 inspects the lower-level substrate in response to the request for input of the inspection data. The worker of the manufacturer inputs a result of inspection into injection molding machine 100 as the inspection data at the time of the shipping inspection.

Higher-level substrate 55 determines whether or not it has received the inspection data at the time of the shipping inspection (step S420). When higher-level substrate 55 has not received the inspection data at the time of the shipping inspection (NO in step S420), it has the process return to step S410. When higher-level substrate 55 has received the inspection data at the time of the shipping inspection (YES in step S420), it writes the received inspection data as the inspection data at the time of the shipping inspection into storage DB1 (step S430).

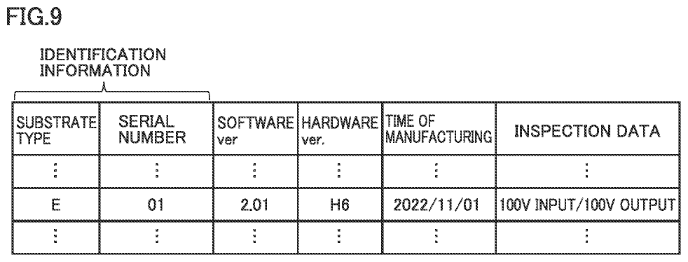

FIG. 9 is a diagram for illustrating the inspection data at the time of the shipping inspection. For description of exemplary inspection data at the time of the shipping inspection, FIG. 9 shows data in storage DB1 on lower-level substrate 50K, the application of which is detection of the voltage value. Inspection of lower-level substrate 50K will be described below.

The worker of the manufacturer of injection molding machine 100 applies a voltage, for example, of 100 V to a test power line and has lower-level substrate 50K detect a value of the voltage that flows through the power line. The worker of the manufacturer determines that lower-level substrate 50K normally operates when lower-level substrate 50K detects the voltage within a prescribed range from 100 V. The worker of the manufacturer determines that lower-level substrate 50K is defective when a result of detection thereby indicates detection of a voltage value out of the prescribed range from 100 V. FIG. 9 shows inspection data of good lower-level substrate 50K and shows that a result of detection in response to the voltage of 100 V was 100 V.

The result of detection in connection with lower-level substrate 50K may gradually deviate from an actual voltage value due to deterioration of lower-level substrate 50K. The worker of the manufacturer of injection molding machine 100 or the user of injection molding machine 100 inspects lower-level substrate 50K after shipping of injection molding machine 100. As in the inspection at the time of the shipping inspection, lower-level substrate 50K is connected to the test power line, the voltage of 100 V is applied to the power line, and lower-level substrate 50K is caused to detect a value of the voltage that flows through the power line. The worker of the manufacturer of injection molding machine 100 or the user of injection molding machine 100 inputs the result of detection into injection molding machine 100. If the result of detection indicates 80 V, a value corresponding to 80% of the actual voltage value is detected as the result of detection due to deterioration of lower-level substrate 50K.

Higher-level substrate 55 determines a compensation value for compensating for lowering of the detection value due to deterioration based on comparison between the inspection data at the time of the shipping inspection and the inspection data after shipping. Higher-level substrate 55 sets 1.25 time as the compensation value, and thereafter obtains the detection value similar to the detection value at the time of the shipping inspection by multiplying the value detected by lower-level substrate 50K by the compensation value. Determination of the compensation value for compensation to the inspection data at the time the shipping inspection will be referred to as “compensation processing” below. Thus, injection molding machine 100 in the third embodiment can achieve suppression of occurrence of erroneous detection due to deterioration of lower-level substrate 50K by inspection after the shipping even when lower-level substrate 50K deteriorates.

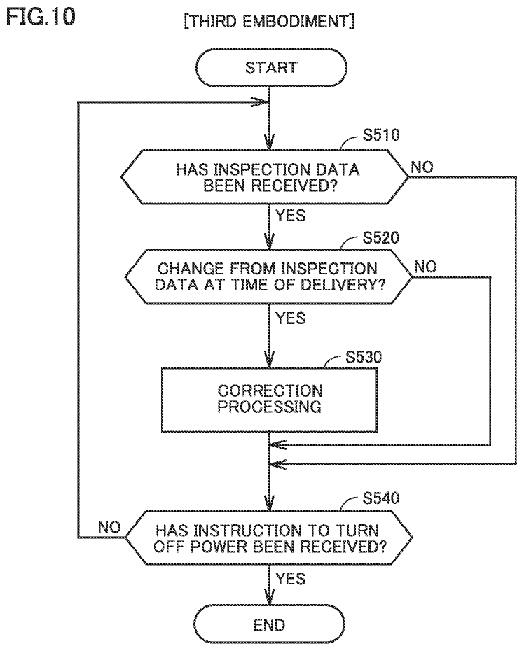

FIG. 10 is a flowchart for illustrating the compensation processing after shipping. Higher-level substrate 55 performs the flowchart in FIG. 10 based on supply of electric power to injection molding machine 100. Higher-level substrate 55 determines whether or not it has received the inspection data (step S510). In other words, the higher-level substrate determines whether or not the worker of the manufacturer of injection molding machine 100 or the user of injection molding machine 100 has inspected the lower-level substrate. When higher-level substrate 55 has not received the inspection data (NO in step S510), it determines whether or not it has received an instruction to turn off power of injection molding machine 100 (step S540).

When higher-level substrate 55 has received the instruction to turn off power of injection molding machine 100 (YES in step S540), it quits the process. When higher-level substrate 55 has not received the instruction to turn off power of injection molding machine 100 (NO in step S540), it has the process return to step S510.

When higher-level substrate 55 has received the inspection data in step S510 (YES in step S510), it determines whether or not there is change from the inspection data at the time of the shipping inspection (step S520). Specifically, higher-level substrate 55 compares the inspection data received in the processing in step S420 in FIG. 8 with the inspection data received in the processing in step S510 in FIG. 10. When there is no change from the inspection data at the time of the shipping inspection (NO in step S520), higher-level substrate 55 has the process proceed to step S540 because the compensation processing is not necessary.

When there is change from the inspection data at the time of the shipping inspection (YES in step S520), higher-level substrate 55 performs the compensation processing (step S530). Injection molding machine 100 in the third embodiment can thus make compensation to detect a value similar to the value at the time of the shipping inspection when the lower-level substrate has deteriorated. Though the lower-level substrate the application of which is detection of the voltage value is described in the third embodiment, the compensation processing may be applicable also to the lower-level substrate for another application described above, so long as the substrate receives input and provides output. For example, in a substrate that carries out A/D conversion of the detection value from the temperature sensor, a digital value to be outputted with respect to an inputted analog value may be corrected.

In the third embodiment as well, whether or not the substrate included in the industrial machine has been replaced is appropriately detected as in injection molding machine 100 in the first embodiment. In other words, injection molding machine 100 in the third embodiment can achieve suppression of occurrence of such an inconvenience as the operation of injection molding machine 100 with the safety standards not being met and use of injection molding machine 100 with the guarantee being void, by detecting whether or not the substrate has been replaced at the timing of start-up of injection molding machine 100.

### ADDITIONAL ASPECTS

Illustrative embodiments described above are understood by a person skilled in the art as specific examples of aspects below.

(Clause 1) An industrial machine includes a higher-level substrate and lower-level substrates communicatively connected to the higher-level substrate. The higher-level substrate is configured to obtain identification information from each of the lower-level substrates at first timing, to obtain identification information from each of the lower-level substrates at second timing following the first timing, and when the identification information obtained at the first timing is different from the identification information obtained at the second timing, to notify a user of substrate replacement of that lower-level substrate for each lower-level substrate.

According to the industrial machine in Clause 1, whether or not the substrate included in the industrial machine has been replaced can appropriately be detected.

(Clause 2) The industrial machine in Clause 1 further includes a storage. When the higher-level substrate determines that substrate replacement has been carried out, the higher-level substrate is configured to cause the storage to store information on substrate replacement.

According to the industrial machine in Clause 2, information on substrate replacement is stored in the storage, so that the user can recognize after substrate replacement that the substrate has been replaced.

(Clause 3) In Clause 2, the industrial machine further includes a display apparatus. Safety standards for protection of a user are defined in advance for the industrial machine. Information indicating whether each of the lower-level substrates relates to the safety standards is stored in the storage for each of lower-level substrates. When the higher-level substrate determines that substrate replacement has been carried out, the higher-level substrate is configured to cause the display apparatus to show a warning when a removed substrate does not relate to the safety standards and to stop an operation of the industrial machine when the removed substrate relates to the safety standards.

According to the industrial machine in Clause 3, occurrence of inconvenience due to substrate replacement can be suppressed in accordance with whether or not the each of lower-level substrates relates to the safety standards.

(Clause 4) In Clause 3, when the higher-level substrate determines that substrate replacement has been carried out and when the removed substrate relates to the safety standards, the higher-level substrate is configured to provide a manufacturer of the industrial machine with information indicating that substrate replacement has been carried out.

According to the industrial machine in Clause 4, the manufacturer of the industrial machine can recognize replacement of the substrate also after shipping of the industrial machine.

(Clause 5) In any one of Clauses 1 to 4, the first timing is timing of shipping of the industrial machine, and the second timing is timing of start-up of the industrial machine based on supply of electric power to the industrial machine.

According to the industrial machine in Clause 5, with a substrate configuration at the time of shipping being defined as the reference, whether or not the substrate has been replaced from the state of the substrate configuration at the time of shipping can be detected.

(Clause 6) In any one of Clauses 1 to 4, the first timing is timing of start-up of the industrial machine based on supply of electric power to the industrial machine, and the second timing is timing of start-up of the industrial machine based on supply of electric power to the industrial machine after the first timing.

According to the industrial machine in Clause 6, whether or not the substrate has been replaced can be detected each time the industrial machine is started up, with the configuration before cut-off of supply of electric power being defined as the reference.

(Clause 7) In any one of Clauses 1 to 6, the higher-level substrate is configured to receive inspection data on a substrate operation from one of the lower-level substrates at the first timing and the second timing and to perform compensation processing for compensating for the substrate operation when the inspection data is different between the first timing and the second timing.

According to the industrial machine in Clause 7, also after the industrial machine is shipped, the substrate can operate in a manner the same as in shipping.

(Clause 8) In any one of Clauses 1 to 7, the industrial machine is an injection molding machine, and the industrial machine further includes a servo motor to be used for clamping of a mold. The lower-level substrates include a first lower-level substrate that controls the servo motor, and the first lower-level substrate is configured to generate a first instruction for control of the servo motor in accordance with an instruction from the higher-level substrate.

According to the industrial machine in Clause 8, substrate replacement in the injection molding machine including the servo motor can appropriately be detected.

(Clause 9) In Clause 8, a safety door attached to a housing that covers the mold and an opening sensor that detects an open and closed state of the safety door are further provided. The lower-level substrates include a second lower-level substrate that receives a detection value from the opening sensor, and the first lower-level substrate controls the servo motor based on information indicating the open and closed state of the safety door received from the second lower-level substrate.

According to the industrial machine in Clause 9, substrate replacement in the injection molding machine including lower-level substrates for control of the servo motor can appropriately be detected.

(Clause 10) In Clause 8, the lower-level substrates include a third lower-level substrate that generates an instruction for control of the servo motor in accordance with an instruction from the higher-level substrate, the third lower-level substrate is configured to transmit the instruction generated by the third lower-level substrate to the first lower-level substrate, and when the instruction generated by the first lower-level substrate is inconsistent with the instruction generated by the third lower-level substrate, the first lower-level substrate is configured to deactivate the servo motor.

According to the industrial machine in Clause 10, substrate replacement in the injection molding machine including lower-level substrates for control of the servo motor can appropriately be detected.

(Clause 11) In any one of Clauses 1 to 10, the higher-level substrate is configured to obtain information indicating time of manufacturing of each lower-level substrate in addition to the identification information from each of the lower-level substrates at the first timing and the second timing.

According to the industrial machine in Clause 11, the user can recognize time of manufacturing of the lower-level substrate included in the industrial machine.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. An industrial machine comprising:
a higher-level substrate; and
lower-level substrates communicatively connected to the higher-level substrate, wherein
the higher-level substrate is configured to
obtain identification information from each of the lower-level substrates at first timing,
obtain identification information from each of the lower-level substrates at second timing following the first timing, and
when the identification information obtained at the first timing is different from the identification information obtained at the second timing, notify a user of substrate replacement of that lower-level substrate for each lower-level substrate.

2. The industrial machine according to claim 1, further comprising a storage, wherein
when the higher-level substrate determines that substrate replacement has been carried out, the higher-level substrate is configured to cause the storage to store information on substrate replacement.

3. The industrial machine according to claim 2, further comprising a display apparatus, wherein
safety standards for protection of a user are defined in advance for the industrial machine,
information indicating whether each of the lower-level substrates relates to the safety standards is stored in the storage for each of lower-level substrates,
when the higher-level substrate determines that substrate replacement has been carried out, the higher-level substrate is configured to
cause the display apparatus to show a warning when a removed substrate does not relate to the safety standards, and
stop an operation of the industrial machine when the removed substrate relates to the safety standards.

4. The industrial machine according to claim 3, wherein
when the higher-level substrate determines that substrate replacement has been carried out and when the removed substrate relates to the safety standards, the higher-level substrate is configured to provide a manufacturer of the industrial machine with information indicating that substrate replacement has been carried out.

5. The industrial machine according to claim 1, wherein
the first timing is timing of shipping of the industrial machine, and
the second timing is timing of start-up of the industrial machine based on supply of electric power to the industrial machine.

6. The industrial machine according to claim 1, wherein
the first timing is timing of start-up of the industrial machine based on supply of electric power to the industrial machine, and
the second timing is timing of start-up of the industrial machine based on supply of electric power to the industrial machine after the first timing.

7. The industrial machine according to claim 1, wherein
the higher-level substrate is configured to
receive inspection data on a substrate operation from one of the lower-level substrates at the first timing and the second timing, and
perform compensation processing for compensating for the substrate operation when the inspection data is different between the first timing and the second timing.

8. The industrial machine according to claim 1, wherein
the industrial machine is an injection molding machine,
the industrial machine further includes a servo motor to be used for clamping of a mold,
the lower-level substrates include a first lower-level substrate that controls the servo motor, and
the first lower-level substrate is configured to generate a first instruction for control of the servo motor in accordance with an instruction from the higher-level substrate.

9. The industrial machine according to claim 8, further comprising:
a safety door attached to a housing that covers the mold; and
an opening sensor that detects an open and closed state of the safety door, wherein
the lower-level substrates include a second lower-level substrate that receives a detection value from the opening sensor, and
the first lower-level substrate controls the servo motor based on information indicating the open and closed state of the safety door received from the second lower-level substrate.

10. The industrial machine according to claim 8, wherein
the lower-level substrates include a third lower-level substrate that generates an instruction for control of the servo motor in accordance with an instruction from the higher-level substrate,
the third lower-level substrate is configured to transmit the instruction generated by the third lower-level substrate to the first lower-level substrate, and
when the instruction generated by the first lower-level substrate is inconsistent with the instruction generated by the third lower-level substrate, the first lower-level substrate is configured to deactivate the servo motor.

11. The industrial machine according to claim 1, wherein
the higher-level substrate is configured to obtain information indicating time of manufacturing of each lower-level substrate in addition to the identification information from each of the lower-level substrates at the first timing and the second timing.
